(19) United States
(12) Patent Application Publication
(10) Pub. No.: US 2002/0127534 A1
(43) Pub. Date: Sep. 12, 2002

(54) Sound equipped luminous clothing accessory

(76) Inventor: Mary Reb, Easton, MD (US)

Correspondence Address: HENDERSON & STURM LLP, 1213 MIDLAND BUILDING, 206 SIXTH AVENUE, DES MOINES, IA, 50309-4076, US

(21) Appl. No.: 09/799,641

(22) Filed: Mar. 6, 2001

(51) Int. Cl. G09B 25/00

(52) U.S. Cl. 434/395

(57) ABSTRACT

A teaching accessory (10) in combination with a specific substrate (100) including children's bedclothes (101) and bedding (102) wherein the teaching accessory (10) includes a hollow fabric envelope (20) that contains an audio unit (12) and has a front face (21) provided with a luminous coating (24) and a variety of different indicia (30) that include alpha-numeric data (31) and graphical representations (32) made from material having different textures, and a rear face (22) having one fastening component (50) that cooperates with another fastening component (51) that is associated with the substrate (100).

### BACKGROUND OF THE INVENTION

### Cross Reference to Related Applications

1. Field of the Invention

The present invention relates to the field of teaching garments in general and in particular to removable clothing accessories that have tactile, audible and visual components to assist a child in the learning process.

2. Description of Related Art

As can be seen by reference to the following U.S. Pat. Nos. 3,624,686; 3,724,101; 5,468,152; 5,718,589, and 4,710,979, the prior art is replete with myriad and diverse teaching garments having both removable accessories and/or permanent display articles that are used to educate a child.

While all of the aforementioned prior art constructions are more than adequate for the basic purpose and function for which they have been specifically designed, they are uniformly deficient with respect to their failure to provide a simple, efficient, and practical removable accessory that has tactile, audible and visual gender targeted components that cooperate with one another to reinforce and substantially enhance the learning process for young children.

In today's society there is a pronounced emphasis on very early education for extremely young children which has spawned a large variety of teaching garments designed to accomplish that objective. However, none of these prior art constructions actively involves all of the primary senses nor uses gender orientation to contribute to the learning process in a manner that will provide intellectual stimulation for the child.

As a consequence of the foregoing situation, there has existed a longstanding need among concerned parents for a new and improved teaching garment that involves the three most important senses used in the learning process (i.e., sight, hearing, and touch). The provision of such an improved teaching garment is the stated objective of the present invention.

### BRIEF SUMMARY OF THE INVENTION

Briefly stated, the improved teaching garment of this invention comprises a plurality of sound equipped luminous clothing that are removably associated with the teaching garments.

Recent studies have been reported which confirm the importance of a good night's sleep in aiding older children and adults in the retention of newly acquired information and the focus of this invention is to apply that theorem to infants' or children's nighttime garments and/or bedding.

As will be explained in greater detail further on in the specification, the primary component of this invention involves a contoured enclosure unit in the form of a fabric envelope which is removably associated with a substrate that would encompass sleep wear or bedding wherein the fabric envelope would have visual, audible and tactile components that would stimulate and reinforce the learning process.

In addition, the fabric envelope is provided with a front face having a variety of different indicia and a luminous coating that allows the indicia to be seen when the light in a bedroom has been turned off so that the last visual impression that a child will have prior to drifting off to sleep will be the indicia on the fabric envelope which should be imprinted on the child's mind while sleeping.

Furthermore, the fabric envelope has a rear face that cooperates with the front face to define a hollow interior which contains an audio unit having prerecorded messages that are associated with the indicia on the front face of the fabric envelope; and, the rear face of the fabric envelope is also provided with securing means for releasably securing the fabric envelope to the substrate such that a variety of different teaching accessories can be employed with the substrate.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is a perspective view of the removable article associated with a child's bedclothes;

FIG. 2 is a perspective view of the removable article associated with a child's bedding;

FIG. 3 is an isolated perspective view of the removable article and cooperating securing means;

FIG. 4 is a cross-sectional view taken through line 4—4 of FIG. 3;

FIGS. 5 through 8 show different representations of the face of the removable article, and;

FIG. 9 is a rear view of the removable article with one of the cooperating fastening components.

### DETAILED DESCRIPTION OF THE INVENTION

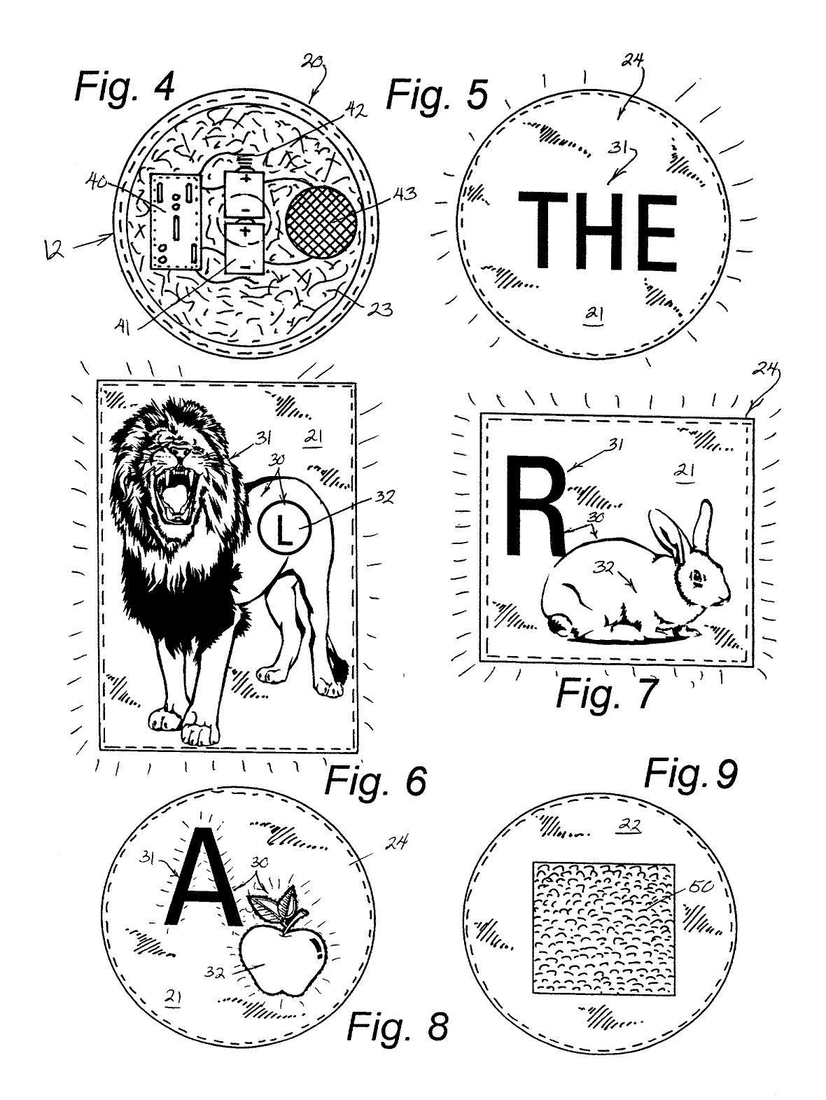

As can be seen by reference to the drawings, and in particular to FIGS. 3 and 4, the sound equipped luminous teaching accessory that forms the basis of the present invention is designated generally by the reference number 10. The teaching accessory 10 comprises in general an enclosure unit 11 provided with an audio 12 and a releasable fastening unit 13. These units will now be described in seriatim fashion.

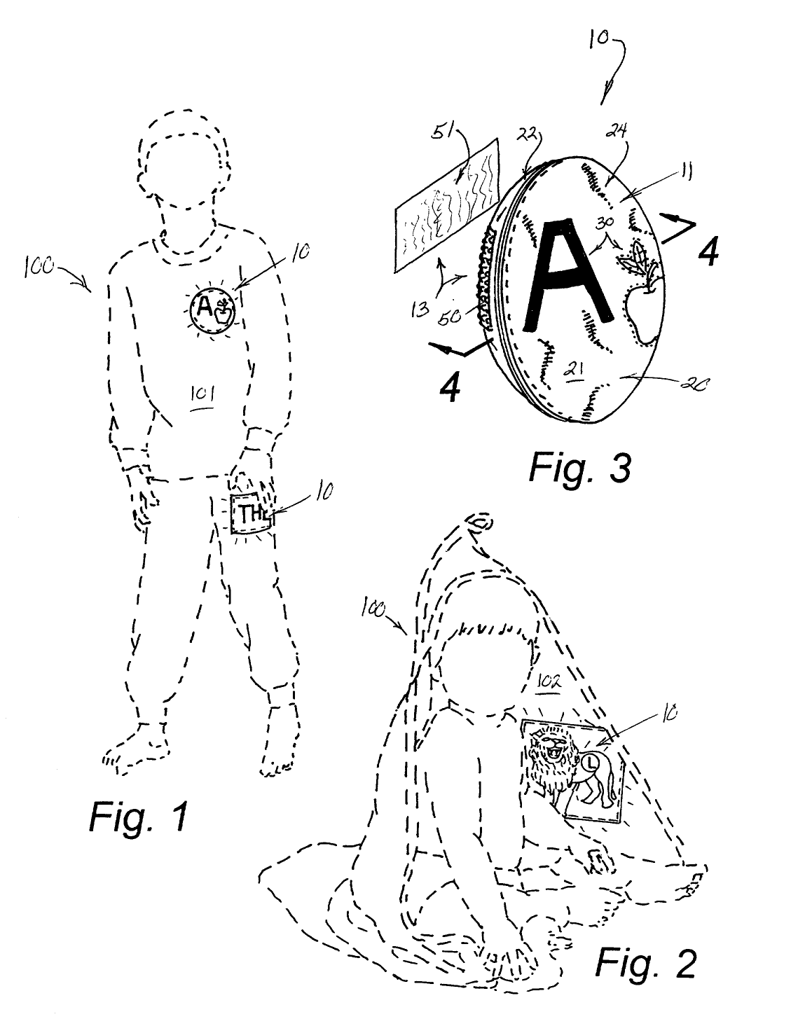

Prior to embarking on a detailed description of the teaching accessory 10, it should first be emphasized that this invention was specifically developed for use with a particular substrate designated generally as 100 and depicted in FIGS. 1 and 2, wherein the substrate 100 includes children's bedclothes 101 and/or bedding 102.

As shown in FIGS. 3 and 4, the enclosure unit 11 comprises a fabric envelope 20 having a front face 21, a rear face 22, and a padded interior 23 that surrounds the audio unit 12.

In addition, the front face 21 of the fabric envelope 20 is provided with a variety of different indicia (designated generally as 30) which includes alpha numeric information 31 and/or graphic representations 32 and is further provided with a luminous coating 24 that allows the indicia 30 to remain visible in a darkened room for reasons that will be explained in greater detail further on in the specification.

As can best be appreciated by reference to FIG. 4, the audio unit 12 comprises a microchip 40 powered by a battery 41 which is controlled by a pressure switch 42 to deliver an audio signal to a microphone 43 in a well recognized fashion.

Furthermore, the microchip 40 is programmed to deliver a recorded message that is directly related to the particular indicia 30 that appears on the front face 21 of the fabric envelope 20.

As can be appreciated by reference to FIGS. 5 through 8, these recorded messages will be educational in nature relating to letters of the alphabet, words or numbers 31 and images 32 associated with the alpha-numeric indicia 31.

For example, in FIG. 5, the recorded message would pronounce the word “the” then spell the “word,” and then would describe what type of word it was such as a noun, pronoun, adjective, etc., and use the word in a sentence.

Other recorded messages would simply recite a letter of the alphabet, relate that letter to a word beginning with that letter and then incorporate a sound associated with the word. For example, in FIG. 6, the message could read “The letter ‘L’ is for lion,” which would be followed by the recorded roar of a lion.

In FIG. 7, the message could read “The letter ‘R’ is for rabbit and rabbits go hippity hop hippity hop.” In FIG. 8, the message could read “The letter ‘A’ is for apples and apples are good to eat,” followed by the sound of somebody biting into an apple.

As can also be appreciated by reference to FIG. 8, in an alternate version of the preferred embodiment, the indicia 30 are provided with a luminous coating 24 versus the front face 21 of the fabric envelope 20.

Obviously, many potential variations of the recorded messages are possible within the teachings of this invention.

Turning now to FIGS. 3 and 9, it can be seen that the releasable fastening unit 13 comprises a pair of cooperating fastening components 50 51 wherein one component 50 is formed on the rear face 22 of the fabric envelope 20 and the other component 51 is attached to the substrate 100.

In the preferred embodiment of the invention, the cooperating fastening components 50 51 comprise hook and loop fasteners. However, it is to be understood that any conventional fasteners could be substituted therefor in keeping with the teachings of this invention.

It should also be noted at this juncture that the indicia 30 in general and in particular the graphic representations 32 are intended to be fabricated from materials having different textures and compositions to provide tactile stimulation for a child.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

I claim:

1. A teaching accessory in combination with a substrate selected from children's bedclothes and bedding wherein the teaching accessory comprises
an enclosure unit including a fabric envelope having a front face, a rear face and a hollow padded interior; wherein the front face of the fabric envelope is further provided with a variety of different indicia and a luminous coating that is selectively applied to the fabric envelope
an audio unit disposed within the interior of the fabric envelope and including a microphone, a power source, a pressure switch and a microchip having programmed recorded messages; and
securing means for releasably connecting said fabric envelope to said substrate.

2. The teaching accessory as in claim 1; wherein, said variety of different indicia includes alpha-numeric data and graphical representations.

3. The teaching accessory as in claim 2; wherein, the luminous coating is applied to the front face of the fabric envelope.

4. The teaching accessory as in claim 2; wherein, the luminous coating is only applied to the variety of different indicia.

5. The teaching accessory as in claim 2; wherein, the luminous coating is only applied to the front face of the fabric envelope.

6. The teaching accessory as in claim 1; wherein, said securing means comprises
a pair of cooperating fastening components wherein one of the fastening components is associated with the rear face of the fabric envelope and the other fastening component is associated with said substrate.

7. The teaching accessory as in claim 2; wherein, said graphical representations are fabricated from materials having different textures.
